(19) United States
(12) Patent Application Publication
(10) Pub. No.: US 2024/0184532 A1
(43) Pub. Date: Jun. 6, 2024

(54) ARITHMETIC CIRCUITRY, MEMORY SYSTEM, AND CONTROL METHOD

(71) Applicant: Kioxia Corporation, Tokyo (JP)

(72) Inventors: Naoaki KOKUBUN, Yokohama (JP); Yuki KONDO, Kawasaki (JP)

(73) Assignee: Kioxia Corporation, Tokyo (JP)

(21) Appl. No.: 18/461,971

(22) Filed: Sep. 6, 2023

(30) Foreign Application Priority Data
Dec. 2, 2022 (JP) 2022-193213

(51) Int. Cl. G06F 7/72; G06F 17/16

(52) U.S. Cl. CPC G06F 7/724; G06F 17/16

(57) ABSTRACT

According to one embodiment, an arithmetic circuitry is configured to: calculate an AND value that is a result of an AND operation of elements a and b of a Galois field; and calculate, for each of a plurality of mutually different sets of (u, v), a \hat{ } (2^{u})×b \hat{ } (2^{v}), which is a product of a 2^{u}-th power of a and a 2^{v}-th power of b, from an XOR operation based on the AND value and a connected tensor obtained by collecting a plurality of tensors different for each set.

### CROSS-REFERENCE TO RELATED APPLICATIONS

This application is based upon and claims the benefit of priority from Japanese Patent Application No. 2022-193213, filed on Dec. 2, 2022; the entire contents of which are incorporated herein by reference.

### FIELD

Embodiments described herein relate generally to an arithmetic circuitry, a memory system, and a control method.

### BACKGROUND

In a memory system, to protect data to be stored in a memory such as a NAND flash memory, error correction encoded data is stored in the memory. For this reason, when the data stored in the memory is read, the error correction encoded data (also referred to as received word) read from the memory is decoded to restore the data before the error correction encoding.

In the technique related to an error correction code, the multiplication of a Galois field (finite field) may be performed. For example, in decoding a Bose-Chaudhuri-Hocquenghem (BCH) code, which is an example of the error correction code, a syndrome is calculated from a received word (read sequence) read from the memory, and a coefficient of an error locator polynomial is calculated from the syndrome. The syndrome is an element of the Galois field. For this reason, when the coefficient of the error locator polynomial is calculated, the multiplication of the syndrome, that is, the multiplication of the Galois field may be performed. As the number of error-correctable bits (t bits, t is an integer of 2 or more) increases, the number of required multiplications of the Galois field increases. That is, the scale of an arithmetic circuitry (multiplier) used for the multiplication increases.

### BRIEF DESCRIPTION OF THE DRAWINGS

FIG. 1 is a block diagram of a memory system according to an embodiment;

FIG. 2 is a block diagram of a decoder according to the embodiment;

FIG. 3 is a diagram illustrating an outline of a calculation procedure of a syndrome and an error locator polynomial;

FIG. 4 is a diagram illustrating an example of a relationship between the syndrome and the error locator polynomial;

FIG. 5 is a diagram illustrating an example of vector representation of an element of a Galois field GF (2⁴);

FIG. 6 is a diagram for explaining an example of a companion matrix;

FIG. 7 is a diagram illustrating an example of a method of obtaining a tensor Tᵢ;

FIG. 8 is a diagram illustrating a specific example of a method of obtaining a tensor T₀;

FIG. 9 is a diagram illustrating an example of a method of obtaining a tensor S;

FIG. 10 is a diagram illustrating a specific example of a method of obtaining the tensor S;

FIG. 11 is a diagram for explaining a procedure of rewriting multiplication;

FIG. 12 is a diagram for explaining an example of a method of obtaining a connected tensor;

FIG. 13 is a diagram illustrating an example of the connected tensor;

FIG. 14 is a diagram for explaining an example of sharing of XOR;

FIG. 15 is a diagram illustrating an example of a sharing method of an XOR operation;

FIG. 16 is a diagram illustrating a configuration example of an arithmetic unit;

FIG. 17 is a diagram illustrating a comparative example of a circuit;

FIG. 18 is a diagram illustrating another configuration example of an arithmetic unit;

FIG. 19 is a diagram illustrating an example of a connected tensor corresponding to an XOR operation by the arithmetic unit of FIG. 18;

FIG. 20 is a diagram illustrating a comparative example of a circuit corresponding to FIG. 18; and

FIG. 21 is a flowchart of decoding processing.

### DETAILED DESCRIPTION

In general, according to one embodiment, an arithmetic circuitry is configured to: calculate an AND value that is a result of an AND operation of an element a and an element b of a Galois field; and calculate, for each of a plurality of mutually different sets of (u, v), a \hat{ } (2^{u})×b \hat{ } (2^{v}), which is a product of a 2^{u}-th power of a and a 2^{v}-th power of b, from an XOR operation based on the AND value and a connected tensor obtained by collecting a plurality of tensors different for each set.

Exemplary embodiments of an arithmetic circuitry will be described below in detail with reference to the accompanying drawings. The present invention is not limited to the following embodiments. Hereinafter, a memory system including an arithmetic circuitry that performs multiplication of a Galois field when decoding an error correction code will be described as an example. A configuration using the arithmetic circuitry is not limited to this example, and any system (apparatus or device) may be used as the configuration. For example, the arithmetic circuitry described below can also be applied to a memory system that performs the multiplication of the Galois field when calculating an error position, a system that performs the multiplication of the Galois field during cipher processing, and the like.

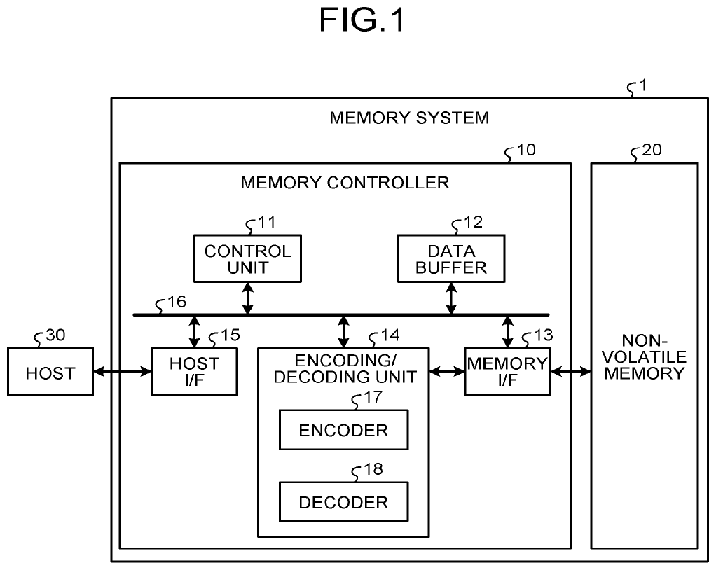

First, a memory system according to the present embodiment will be described in detail with reference to the drawings. FIG. 1 is a block diagram illustrating a schematic configuration example of a memory system according to the present embodiment. As illustrated in FIG. 1, the memory system 1 includes a memory controller 10 and a non-volatile memory 20. The memory system 1 can be connected to a host 30, and FIG. 1 illustrates the memory system 1 connected to the host 30. The host 30 may be, for example, an electronic device such as a personal computer or a mobile terminal.

The non-volatile memory 20 is a non-volatile memory that stores data in a non-volatile manner, and is, for example, a NAND flash memory (hereinafter, simply referred to as a NAND memory). Although a case where a NAND memory is used as the non-volatile memory 20 will be exemplified in the following description, a storage device other than the NAND memory, such as a three-dimensional structure flash memory, a resistive random access memory (ReRAM), or a ferroelectric random access memory (FeRAM), can be used as the non-volatile memory 20. In addition, the non-volatile memory 20 is not necessarily a semiconductor memory, and the present embodiment can also be applied to various storage media other than the semiconductor memory.

The memory system 1 may be various memory systems including the non-volatile memory 20, such as a so-called solid state drive (SSD) or a memory card in which the memory controller 10 and the non-volatile memory 20 are configured as one package.

The memory controller 10 controls writing to the non-volatile memory 20 in accordance with a write request from the host 30. In addition, the memory controller 10 controls reading from the non-volatile memory 20 in accordance with a read request from the host 30. The memory controller 10 is, for example, a semiconductor integrated circuit configured as a system on a chip (SoC). The memory controller 10 includes a host interface (host I/F) 15, a memory interface (memory I/F) 13, a control unit 11, an encoding/decoding unit (CODEC) 14, and a data buffer 12. The host I/F 15, the memory I/F 13, the control unit 11, the encoding/decoding unit 14, and the data buffer 12 are mutually connected by an internal bus 16. Some or all of operations of each component of the memory controller 10 described below may be implemented by a central processing unit (CPU) executing firmware or may be implemented by hardware.

The host I/F 15 erforms processing according to an interface standard with the host 30, and outputs a command received from the host 30, user data to be written, and the like to the internal bus 16. In addition, the host I/F 15 transmits user data read from the non-volatile memory 20 and restored, a response from the control unit 11, and the like to the host 30.

The memory I/F 13 performs write processing to the non-volatile memory 20 based on an instruction from the control unit 11. In addition, the memory I/F 13 performs read processing from the non-volatile memory 20 based on the instruction from the control unit 11.

The control unit 11 integrally controls each component of the memory system 1. When a command is received from the host 30 via the host I/F 15, the control unit 11 performs control according to the command. For example, the control unit 11 instructs the memory I/F 13 to write the user data and a parity to the non-volatile memory 20 in accordance with a command from the host 30. In addition, the control unit 11 instructs the memory I/F 13 to read the user data and the parity from the non-volatile memory 20 in accordance with a command from the host 30.

In addition, when a write request is received from the host 30, the control unit 11 determines a storage area (memory area) on the non-volatile memory 20 for the user data accumulated in the data buffer 12. That is, the control unit 11 manages a write destination of the user data. The correspondence between the logical address of the user data received from the host 30 and the physical address indicating the storage area on the non-volatile memory 20 storing the user data is stored as an address conversion table.

In addition, when a read request is received from the host 30, the control unit 11 converts a logical address designated by the read request into a physical address using the above-described address conversion table, and instructs the memory I/F 13 to perform reading from the physical address.

In the NAND memory, writing and reading are generally performed in data units called pages, and erasing is performed in data units called blocks. In the present embodiment, a plurality of memory cells connected to the same word line is referred to as a memory cell group. When the memory cell is a single level cell (SLC), one memory cell group corresponds to one page. When the memory cell is a multiple level cell (MLC), one memory cell group corresponds to a plurality of pages. In the present description, the MLC includes a triple level cell (TLC), a quad level cell (QLC), and the like. Each memory cell is connected to the word line and is also connected to a bit line. Therefore, each memory cell can be identified by an address for identifying the word line and an address for identifying the bit line.

The data buffer 12 temporarily stores the user data received from the host 30 by the memory controller 10 until the user data is stored in the non-volatile memory 20. In addition, the data buffer 12 temporarily stores the user data read from the non-volatile memory 20 until the user data is transmitted to the host 30. As the data buffer 12, for example, a general-purpose memory such as a static random access memory (SRAM) or a dynamic random access memory (DRAM) can be used. Note that the data buffer 12 may be mounted outside the memory controller 10 instead of being built in the memory controller 10.

The user data transmitted from the host 30 is transferred to the internal bus 16 and temporarily stored in the data buffer 12. The encoding/decoding unit 14 encodes the user data to be stored in the non-volatile memory 20 and generates a code word. In addition, the encoding/decoding unit 14 decodes the received word read from the non-volatile memory 20 and restores the user data. Therefore, the encoding/decoding unit 14 includes an encoder 17 and a decoder 18. Note that the data encoded by the encoding/decoding unit 14 may include control data or the like used inside the memory controller 10 in addition to the user data.

Next, the write processing of the present embodiment will be described. The control unit 11 instructs the encoder 17 to encode the user data during writing to the non-volatile memory 20. At that time, the control unit 11 determines a storage location (storage address) of the code word in the non-volatile memory 20, and also instructs the memory I/F 13 on the determined storage location.

The encoder 17 encodes the user data on the data buffer 12 based on the instruction from the control unit 11 and generate a code word. As the encoding method, for example, an encoding method using an algebraic code such as a Bose-Chaudhuri-Hocquenghem (BCH) code and a Reed-Solomon (RS) code, and an encoding method (product code or the like) using these codes as component codes in the row direction and the column direction can be employed. The memory I/F 13 performs control to store the code word in the storage location on the non-volatile memory 20 instructed from the control unit 11. Hereinafter, a case of using a BCH code for correcting an error of t bits (t is an integer of 2 or more) or less will be described as an example.

Next, processing during reading from the non-volatile memory 20 of the present embodiment will be described. The control unit 11 designates an address on the non-volatile memory 20 and instructs the memory I/F 13 to perform reading during reading from the non-volatile memory 20. In addition, the control unit 11 instructs the decoder 18 to start decoding. The memory I/F 13 reads a received word from a designated address of the non-volatile memory 20 in accordance with the instruction of the control unit 11, and inputs the read received word to the decoder 18. The decoder 18 decodes the received word read from the non-volatile memory 20.

The decoder 18 decodes the received word read from the non-volatile memory 20. The decoder 18 calculates an error locator polynomial using, for example, the Peterson Gorenstein Zierler (PGZ) method. The PGZ method is a method of solving a simultaneous equation established between a coefficient σ of an error locator polynomial and a syndrome using matrix calculation.

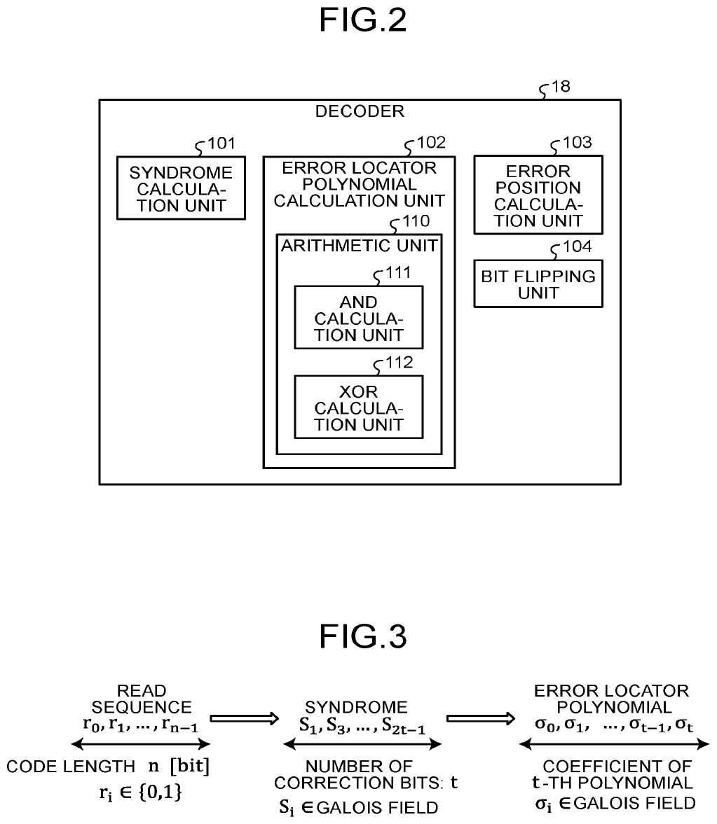

FIG. 2 is a block diagram illustrating a configuration example of the decoder 18 according to the present embodiment. As illustrated in FIG. 2, the decoder 18 includes a syndrome calculation unit 101, an error locator polynomial calculation unit 102, an error position calculation unit 103, and a bit flipping unit 104.

The syndrome calculation unit 101 calculates a syndrome using a received word (read sequence) read from the non-volatile memory 20. The syndrome calculation unit 101 may calculate the syndrome based on any conventionally used method. When the values of all the syndromes are 0, it can be determined that the received word has no errors, and thus the decoder 18 can end the decoding processing without performing the subsequent processing.

The error locator polynomial calculation unit 102 calculates the error locator polynomial based on the PGZ method using the syndrome. Some of the coefficients of the error locator polynomials are calculated by adding and multiplying the syndromes.

FIG. 3 is a diagram illustrating an outline of a calculation procedure of a syndrome and an error locator polynomial in the case of the BCH code. A read sequence r₀, r₁, r₂, . . . , rₙ₋1 having a code length of n bits is read from the non-volatile memory 20 as received words. The syndrome calculation unit 101 receives these received words and calculates syndromes S₁, S₃, . . . , and S₂ₜ₋₁. The error locator polynomial calculation unit 102 calculates coefficients σ₀, σ₁, . . . , σₜ₋₁, and σₜ of the t-th degree error locator polynomial from the syndromes. As illustrated in FIG. 3, the syndromes and the coefficients o calculated using the syndromes are the elements of the Galois field.

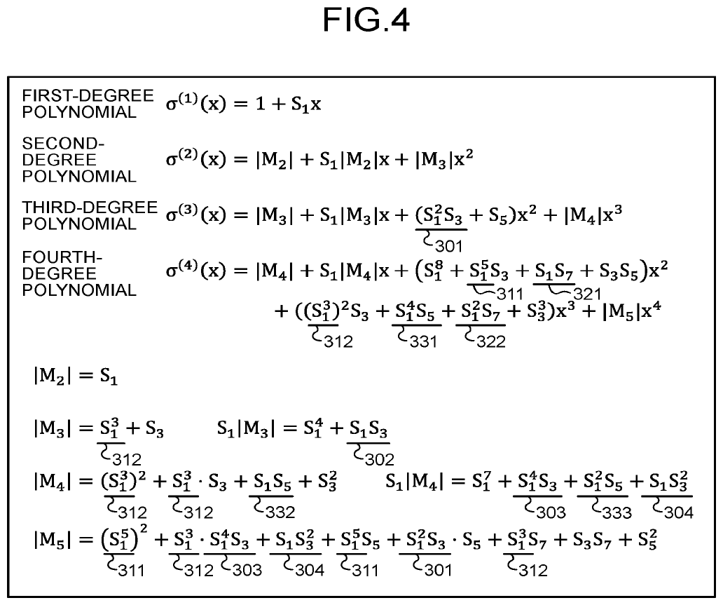

FIG. 4 is a diagram illustrating an example of a relationship between the syndrome and the error locator polynomial. Note that FIG. 4 illustrates an example of error locator polynomials of first to fourth degrees (first-degree polynomial to fourth-degree polynomial) when a BCH code that corrects errors of four bits (t=4) or less is used. |M₂|, |M₃|, |M₄|, and |M₅| included in any of the second-degree polynomial to the fourth-degree polynomial are each calculated by the formula illustrated in the lower part of FIG. 4.

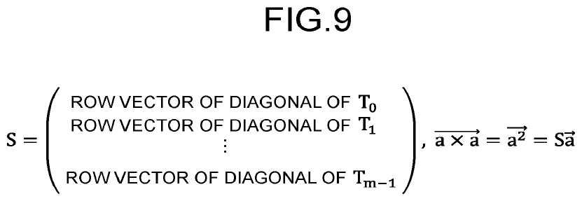

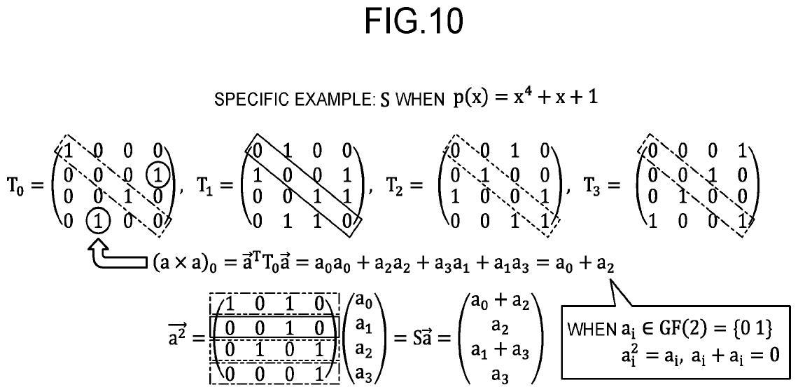

The first-degree to fourth-degree polynomials are formulas for calculating error positions when the number of errors is 1 to 4, respectively. In the example of FIG. 4, the number of multipliers required to calculate the coefficients of each of the formulas of the first-degree polynomial to the fourth-degree polynomial is, for example, 0, 1, 5, and 21, respectively, except for the square of an element of the Galois field, which can be realized by simple calculation described with reference to FIGS. 9 and 10. Thus, as the number of error-correctable bits t increases, the number of multipliers for calculating the coefficient of the error locator polynomial increases.

Therefore, in the present embodiment, an arithmetic circuitry optimized to be able to commonly calculate at least a part of multiplication of syndromes used in the calculation of the coefficients of the error locator polynomial (arithmetic unit 110 in FIG. 2) is used. This makes it possible to suppress an increase in the circuit scale for performing the multiplication of the Galois field.

For example, in FIG. 4, multiplications 301 to 304 included in the coefficients include the multiplication of the syndromes S₁ and S₃. All the multiplications 311 to 312 include the multiplication of the syndrome S₁ (power not the square of S₁). Multiplications 321 to 322 include the multiplication of the syndromes S₁ and S₇. Multiplications 331 to 333 include the multiplication of the syndromes S₁ and S₅.

The arithmetic unit 110 is configured to efficiently calculate a plurality of multiplications including a common multiplication as described above. Hereinafter, a case where the arithmetic unit 110 is configured to calculate a set of the multiplications 301 to 304 including the multiplication of the syndromes S₁ and S₃ will be described as an example. The arithmetic unit 110 may be configured to calculate another set of multiplications, or may be configured to calculate two or more sets of multiplications.

Returning to FIG. 2, the arithmetic unit 110 (an example of an arithmetic circuitry) will be further described. As illustrated in FIG. 2, the error locator polynomial calculation unit 102 includes the arithmetic unit 110 that performs the calculation of the elements of the Galois field including the multiplication of the elements of the Galois field. The arithmetic unit 110 includes an AND calculation unit 111 and an XOR calculation unit 112.

The AND calculation unit 111 performs an AND operation for performing the multiplication of the elements of the Galois field. The XOR calculation unit 112 performs an XOR operation for performing the multiplication of the elements of the Galois field. Details of the AND calculation unit 111 and the XOR calculation unit 112 will be described later.

Note that the arithmetic unit 110 is a configuration unit that performs at least part of the multiplication of syndromes required for the calculation of the coefficients of the error locator polynomial. The multiplication of syndromes not performed by the arithmetic unit 110 is calculated, for example, by the error locator polynomial calculation unit 102. In this case, the error locator polynomial calculation unit 102 may calculate the coefficient (including the multiplication of the syndrome) based on any conventionally used method.

The error position calculation unit 103 calculates the error position using the error locator polynomial calculated by the error locator polynomial calculation unit 102. The processing for calculating the error position (search processing) may be implemented by any method, and for example, Chien search can be used. The Chien search is a method of sequentially substituting a value into an error locator polynomial and searching for the error position based on a value at which the output value of the error locator polynomial becomes 0.

The bit flipping unit 104 performs error correction by inverting (bit flipping) the bit at the error position calculated by the search processing.

Next, details of the arithmetic unit 110 (AND calculation unit 111 and XOR calculation unit 112) will be described. The arithmetic unit 110 performs, for example, the following procedure.

(P1) Determine m defining the number of elements 2^{m} of the Galois field and a primitive polynomial p (x) of m-th degree.

(P2) Obtain a companion matrix corresponding to the primitive polynomial p (x).

(P3) Obtain a plurality of tensors used in the multiplication of the elements of the Galois field using the companion matrix. When an element of the Galois field is expressed by an m-dimensional vector, an element which is an output obtained by multiplying two elements is also expressed by the m-dimensional vector. The tensor is obtained for each component of the element of the output expressed by the m-dimensional vector. That is, a total of m tensors, each of which is a function whose input is two vectors and whose output is one value (one component of the vector), are obtained. Hereinafter, a tensor defined for the i-th component (i is an integer satisfying 0≤i≤m−1) of the m-dimensional vector is represented as Tᵢ. The tensor Tᵢ may be referred to as a second-rank tensor because the number of input vectors is two. In addition, the entire m second-rank tensors are characterized by three subscripts, and thus may be referred to as a third-rank tensor.

(P4) A second-rank tensor S representing the square of the elements of the Galois field is obtained.

(P5) For a set of multiplications to be calculated by the arithmetic unit 110 (for example, the multiplications 301 to 304), each multiplication is rewritten by an AND operation of components of an m-dimensional vector, which are two commonly included arguments, and a tensor described by the tensor Tᵢ and the tensor S. The number of rewritten tensors obtained is the number of multiplications included in the set of multiplications. In the set of the multiplications 301 to 304, four tensors are obtained since four types of multiplications (S₁²S₃, S₁S₃, S₁⁴S₃, and S₁S₃²) are included.

(P6) A tensor combining the plurality of obtained tensors (hereinafter referred to as a connected tensor) is calculated.

(P7) Among a plurality of XOR operations represented by the connected tensor, an XOR operation that can be shared is shared (optimized).

(P8) The arithmetic unit 110 is configured to perform an XOR operation according to the connected tensor after sharing.

Each of the above procedures will be further described below.

Regarding (P1), the definition of the Galois field will be described. The Galois field is determined by m ϵ {1, 2, 3 . . . } defining the number of elements and a primitive polynomial p (x) of m-th degree. The Galois field has the following characteristics.
It has 2^{m} elements consisting of one zero element, 0, and (2^{m}−1) non-zero elements.
Any non-zero element can be expressed by the power of a primitive element α, which is the root of the primitive polynomial p (x), as in the following formula (1).

$$GF ( {2}^{m} ) := \{ 0 , {α}^{0} ( = 1 ) , {α}^{1} , {α}^{2} , … , {α}^{2 m - 2} \} , \qquad ( 1 )$$

$$p ( x = α ) = 0$$

In the BCH code having a code length n=2^{m}−1 (m is an integer of 2 or more), for example, a Galois field GF (2^{m}) having 2^{m} elements is used. The element of the Galois field GF (2^{m}) can be represented by an m-bit vector (m-dimensional vector).

For example, any element a ϵ GF (2^{m}) of the Galois field GF (2^{m}) can be expressed by a polynomial on GF (2) of (m−1) -th degree with respect to the primitive element α as in the following formula (2). Note that i is an integer satisfying 0≤i≤m−1.

$$a = {a}_{0} {α}^{0} + {a}_{1} {α}^{1} + {a}_{2} {α}^{2} + … + {a}_{m - 1} {α}^{m - 1} , \qquad ( 2 )$$

$${a}_{i} ∈ \{ 0 , 1 \} = GF ( 2 )$$

Therefore, the element a can be expressed by an m-dimensional vector on GF (2) having a coefficient of a polynomial on GF (2) as a component, as illustrated in the following formula (3).

$$\vec{a} = ( {a}_{0} , {a}_{1} , {a}_{2} , … , {a}_{m - 1} ) \qquad ( 3 )$$

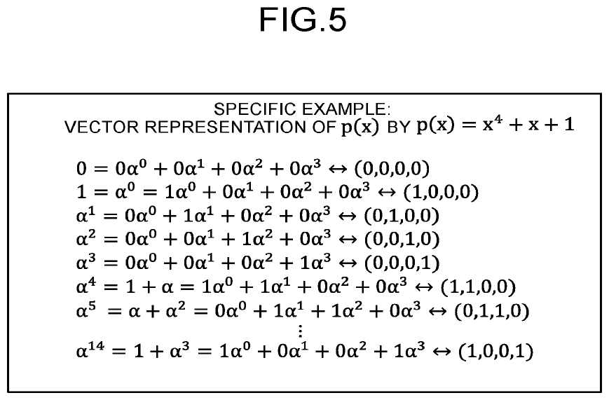

For example, the element of the Galois field GF (b 2¹⁰) used in the BCH code having a code length of n=2¹⁰−1 can be represented by a 10-bit vector. In addition, the element of the Galois field GF (2⁴) used with the BCH code having a code length of n=2⁴−1 can be represented by a 4-bit vector. FIG. 5 illustrates an example of the vector representation of the element of the Galois field GF (2⁴) in which m=4 and the primitive polynomial is represented by p (x)=x⁴+x+1.

For example, the element 0 is represented by a polynomial 0α⁰+0α¹+0α²+0α³, and is represented by a four-dimensional vector (0, 0, 0, 0) having the coefficients of the polynomial as components. Since the primitive element a satisfies the primitive polynomial p (α)=α⁴+α+1=0, in other words, satisfies α⁴=α+1, the element α⁴ can be transformed into 1+α. Therefore, for example, the element α⁴ is represented by a polynomial 1α⁰+1α¹+0α²+0α³, and is represented by a four-dimensional vector (1, 1, 0, 0) having the coefficients of the polynomial as components.

In addition, the addition of the elements of the Galois field is represented by the XOR of two vectors for each bit. In the present embodiment, the multiplication of the element of the Galois field is performed by an arithmetic circuitry combining an AND operation and an XOR operation.

In (P1), first, m that defines the number of elements of the Galois field to be calculated is determined. The value of m may be determined in any manner, and may be determined according to, for example, the encoding system applied and the type of memory applied. For example, in a case where the memory system 1 uses a BCH code having a code length of 1000 bits, m is determined to be 10 to include the number of elements (2¹⁰=1024>1000) larger than the code length. In the Galois field, one or more primitive polynomials are defined for each value of m. Among these primitive polynomials, one primitive polynomial to be used is determined.

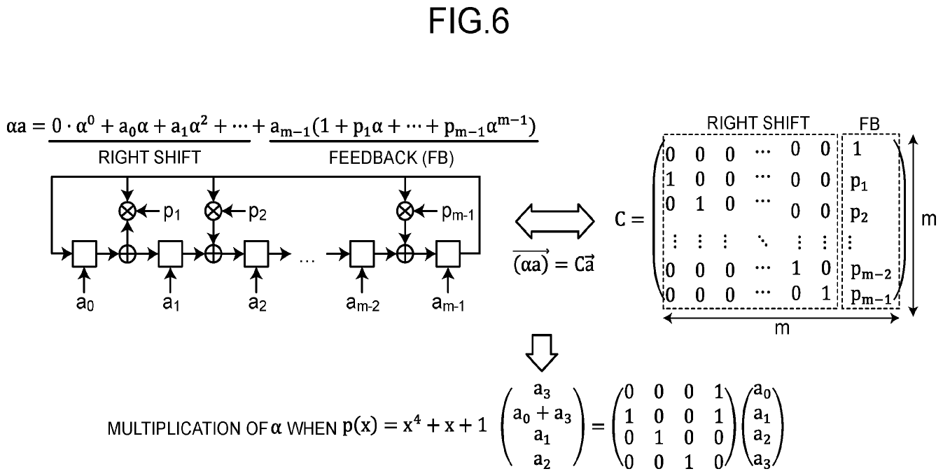

Next, (P2) will be described. After the primitive polynomial p (x) is determined, a matrix called a companion matrix is determined. FIG. 6 is a diagram illustrating an example of the companion matrix.

The multiplication of the element a and the primitive element α of the Galois field can be expressed by the multiplication of the companion matrix C and the vector representing the element a. The multiplication with the primitive element α can be divided into a calculation corresponding to right shift and a calculation corresponding to feedback (FB). The circuit in FIG. 6 illustrates an example of a circuit corresponding to such right shift and feedback. The feedback can be interpreted as processing for a term that overflows due to the right shift. The companion matrix C can also be divided into a column (column 1 to column (m−1)) corresponding to the right shift and a column (column m) corresponding to the feedback.

For example, the multiplication of a in the Galois field GF (2⁴) in which the primitive polynomial is represented by p (x)=x⁴+x+1 can be represented by the multiplication of the companion matrix C and the element a as illustrated in the formula in the lower part of FIG. 6. In the procedure (P2), the companion matrix corresponding to the determined primitive polynomial is determined in this manner.

Next, (P3) will be described. In (P3), m tensors Tᵢ used in the multiplication of the elements of the Galois field are obtained using the companion matrix. If m=10, 10 tensors from T₀ to T₉ are obtained.

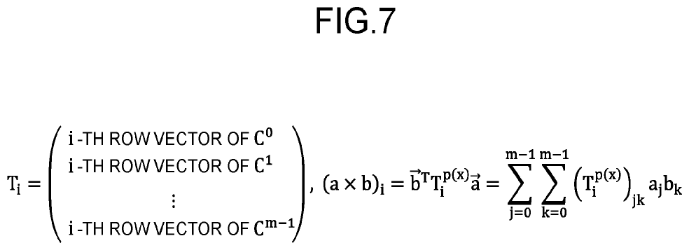

FIG. 7 is a diagram illustrating an example of a method of obtaining the tensor Tᵢ. As illustrated in FIG. 7, the tensor Tᵢ is obtained by arranging i-th row vectors of the matrices C⁰ to C^{m-}1. Note that the matrix C^{p} (p is an integer satisfying 0≤p≤m−1) means the p-th power of the companion matrix C.

FIG. 7 also illustrates an example of an expression indicating the relationship between the tensor Tᵢ and the multiplication of the elements a and b of the Galois field. (a×b)ᵢ represents the i-th bit of the m-bit vector indicating the result of the multiplication of the elements a and b. As illustrated in FIG. 7, (a×b)ᵢ can be represented by the multiplication of the vector indicating the element a, the vector indicating the element b, and the tensor Tᵢ. Note that the symbol “T” on the upper right of the element b represents transposition of a vector or a matrix. In addition, (a×b)ᵢ can be represented in a form of a sum of AND operations of the j-th component aⱼ of a (j is an integer satisfying 0≤j≤m−1 ) and the k-th component bₖ of b (k is an integer satisfying 0≤k≤m−1).

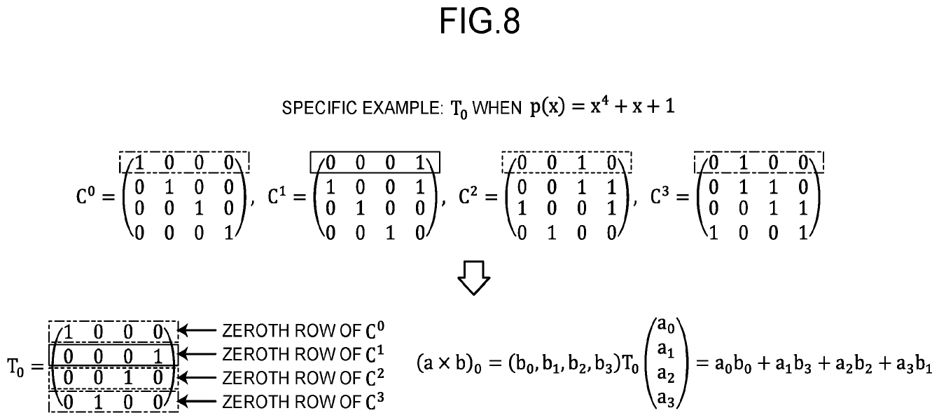

FIG. 8 is a diagram illustrating a specific example of a method of obtaining the tensor To in the case of m=4 and the primitive polynomial p (x)=x⁴+x+1. First, matrices C⁰ to C³ are obtained from the companion matrix C. The tensor T₀ is obtained by arranging the zeroth row of each of the matrices C⁰ to C³. Using this tensor T₀, (a×b)₀ is represented as a₀b₀+a₁b₃+a₂b₂+a₃b₁. Similarly, tensors T₁, T₂, and T₃ can be determined.

Next, (P4) will be described. The tensor S representing the square of the element of the Galois field can be obtained from the tensor Tᵢ. FIG. 9 is a diagram illustrating an example of a method of obtaining the tensor S. As illustrated in FIG. 9, the tensor S is obtained by setting a diagonal component of the tensor Tᵢ as an i-row vector.

FIG. 9 also illustrates an example of a formula indicating the relationship between the tensor S and the square of the element a of the Galois field (multiplication of the element a and the element a). As illustrated in FIG. 9, the square (a×a) of the element a can be represented by the multiplication of a vector indicating the element a and the tensor S.

FIG. 10 is a diagram illustrating a specific example of a method of obtaining the tensor S in the case of m=4 and the primitive polynomial p (x)=x⁴+x+1. The tensor S is obtained by arranging diagonal components of each of the tensors T₀ to T₃. Using this tensor S, a² (=a×a) is calculated as a vector (a₀+a₂, a₂, a₁+a₃, a₃).

The reason why only the diagonal components are extracted is that the components symmetrical with respect to the main diagonal are canceled and become 0. For example, (a×a)₀ corresponding to the tensor T₀ is a₀a₀+a₂a₂+a₃a₁+a₁a_{3.} In GF (2), the square a² of the element a is equal to a, and the addition (a+a) of the same element a is 0. For example, a₀a₀ and a₂a₂ are a₀ and a₂, respectively. In addition, a₃a₁+a₁a₃ is the addition of the same element and thus 0. Therefore, a₀a₀+a₂a₂+a₃a₁+a₁a₃ is expressed as a₀+a₂.

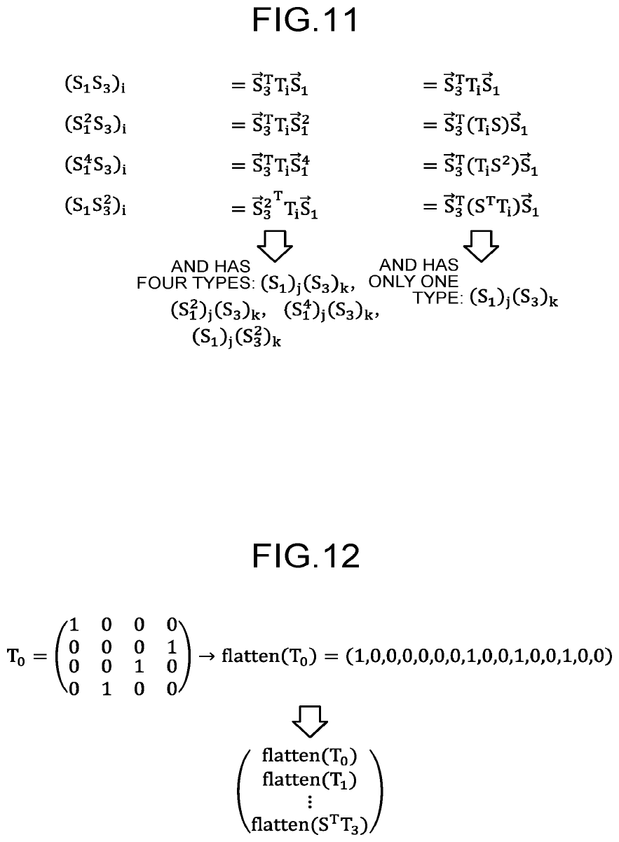

Next, (P5) will be described. Hereinafter, an example of rewriting the multiplications S₁S₃, S₁²S₃, S₁⁴S₃, and S₁S₃² included in the set of the multiplications 301 to 304 will be described. FIG. 11 is a diagram for explaining a procedure of rewriting the multiplication. In the present embodiment, two values to be multiplied are referred to as arguments. For example, the multiplication S₁S₃ is the multiplication of an argument S₁ and an argument S₃.

As illustrated in the middle of FIG. 11, each multiplication can be expressed in the form of a multiplication sandwiching the tensor Tᵢ between two arguments. In this format, the same tensor Tᵢ is used, but the arguments are different from each other. Therefore, for example, as the AND operation included in the formula on the right of FIG. 7, four types of AND operations of (S₁)ⱼ(S₃)ₖ, (S₁²)ⱼ(S₃)ₖ, (S₁⁴)ⱼ(S₃)ₖ, and (S₁)ⱼ(S₃²)ₖ are required.

Therefore, in the present embodiment, the format illustrated in the center of FIG. 11 is rewritten to a format including the same argument and having a different tensor. For the rewriting, a modification of the formula illustrated in the following formula (4) can be used. Herein, each of u and v is an integer.

$$\begin{matrix}{( {a}^{{2}^{u}} \times {b}^{{2}^{v}} )}_{i} = {( {\vec{b}}^{{2}^{v}} )}^{T} {T}_{i} {\vec{a}}^{{2}^{u}} \\ = {( {S}^{v} \vec{b} )}^{T} {T}_{i} ( {S}^{u} \vec{a} ) \\ = {\vec{b}}^{T} \{ {( {S}^{v} )}^{T} {T}_{i} {S}^{u} \} \vec{a}\end{matrix} \qquad ( 4 )$$

As described above, the tensor used in each multiplication is represented by the following formula (5) including the tensor Tᵢ, the linear operation S^{u} representing the 2^{u}-th power, and the linear operation S^{v} representing the 2^{v}-th power.

$${( {S}^{v} )}^{T} {T}_{i} {S}^{u} \qquad ( 5 )$$

In the example of FIG. 11, the tensor corresponding to each multiplication is obtained as follows.

Since S₁S₃: u=0 and v=0, (S⁰)^{T}×Tᵢ×S⁰=Tᵢ.

Since S₁²S₃: u=1 and v=0, (S₀)^{T}×Tᵢ×S¹=TᵢS.

Since S₁⁴S₃: u=2 and v=0, (S₀)^{T}×Tᵢ×S₂=TᵢS₂.

Since S₁S₃²: u=0 and v=1, (S₁)^{T}×Tᵢ×S₀=S^{T}Tᵢ.

In the rewritten format, since the argument is one type, S₁ and S₃, only one type of AND operation of (S₁)ⱼ(S₃)ₖ is required. Therefore, the scale of the circuit for the AND operation can be reduced.

Next, (P6) will be described. The plurality of tensors determined for each multiplication are combined into one connected tensor. FIG. 12 is a diagram for explaining an example of a method of obtaining a connected tensor.

For example, the connected tensor is obtained by converting each of the plurality of tensors into a one-dimensional vector and using the converted vector as a vector of each row. In FIG. 12, the function of converting the tensor into a one-dimensional vector is represented as “flatten.” For example, the tensor To can be converted into a one-dimensional vector (1, 0, 0, 0, 0, 0, 0, 1, 0, 0, 1, 0, 0, 1, 0, 0).

As described above, the tensor Tᵢ is obtained for each component of the m-dimensional vector representing the element of the Galois field. Therefore, in the example of FIG. 11, 4 (m=4) tensors are obtained for each of the four types of multiplications. In this case, the connected tensor is a tensor obtained by connecting (linking) 16 (4 types×4) tensors.

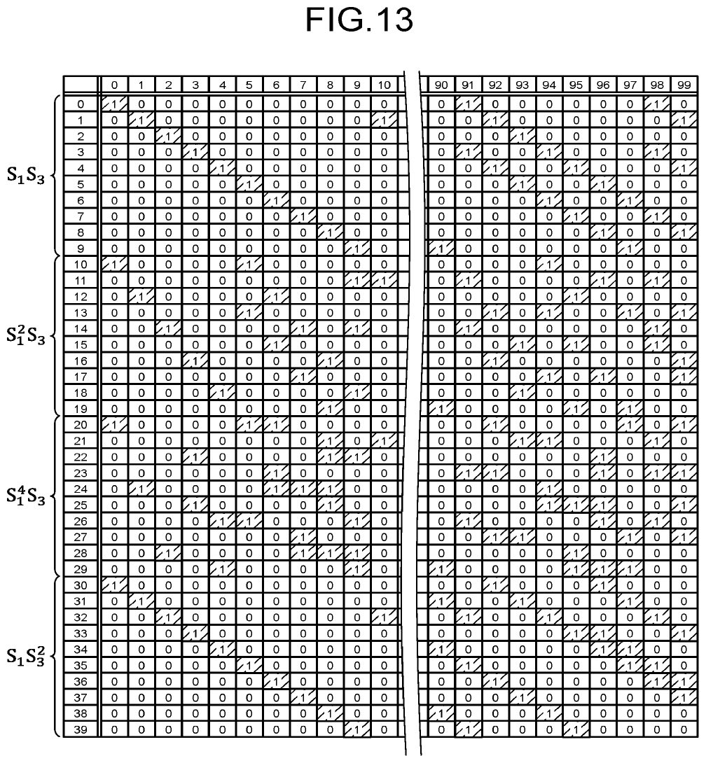

In the case of m=10, the connected tensor is a tensor obtained by connecting 40 (4 types×10) tensors. FIG. 13 is a diagram illustrating an example of the connected tensor in the case of m=10. The (j+10k)-th column corresponds to (S₁)ⱼ(S₃)ₖ, which is an AND operation using a common argument. A column having a value of 1 is used in the addition (XOR) for obtaining the multiplication of the corresponding row (4 types×10 in the example of FIG. 13). A column having a value of 0 is not used in the addition. For example, the second row of the connected tensor corresponds to the multiplication (S₁S₃)₁. Then, the multiplication (S₁S₃)₁ is calculated by the addition of arguments (XOR) according to the following formula (6).

$${( {S}_{1} {S}_{3} )}_{1} = {( {S}_{1} )}_{1} {( {S}_{3} )}_{0} + {( {S}_{1} )}_{0} {( {S}_{3} )}_{1} + … + {( {S}_{1} )}_{2} {( {S}_{3} )}_{9} + {( {S}_{1} )}_{9} {( {S}_{3} )}_{9} \qquad ( 6 )$$

Next, (P7) will be described. (P7) is a procedure for sharing an operation that can be shared among a plurality of XOR operations defined by the connected tensor. As a result, the scale of the circuit for the XOR operation can be reduced.

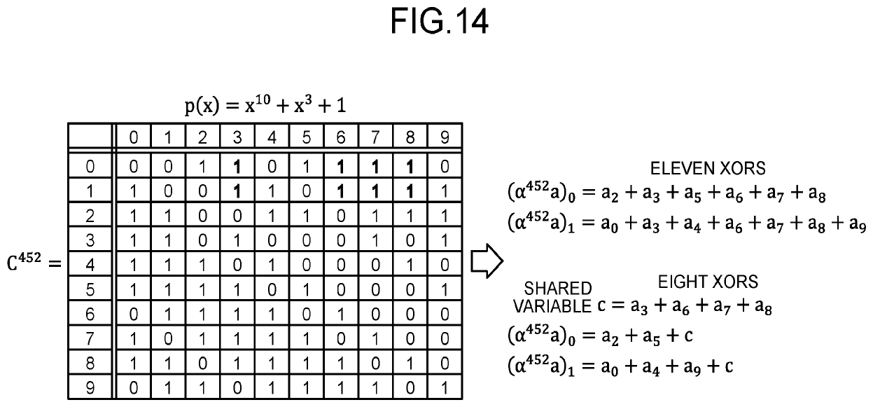

FIG. 14 is a diagram for explaining an example of XOR sharing. In FIG. 14, an example of sharing will be described using a tensor corresponding to the 452nd power of the companion matrix C (C⁴⁵²) in the case of the primitive polynomial p (x)=x¹⁰+x³+1. For example, the 0th component (α⁴⁵²a)₀ of the multiplication of the element a and the matrix C⁴⁵² is represented as a²+a³+a⁵+a⁶+a⁷+a₈, and the first component (α⁴⁵²a)₁ is represented as a₀+a₃+a₄+a₆+a₇+a₈+a₉. A total of 11 XOR operations are required for these two components.

A shared variable c=a₃+a₆+a₇+a₈ as including a term common to these two components is defined. When the shared variable is used, the 0-th component (α⁴⁵²a)₀ is represented as a₂+a₅+c, and the first component (α⁴⁵²a)₁ is represented as a₀+a₄+a₉+c. As a result, the number of required XOR operations is reduced to eight.

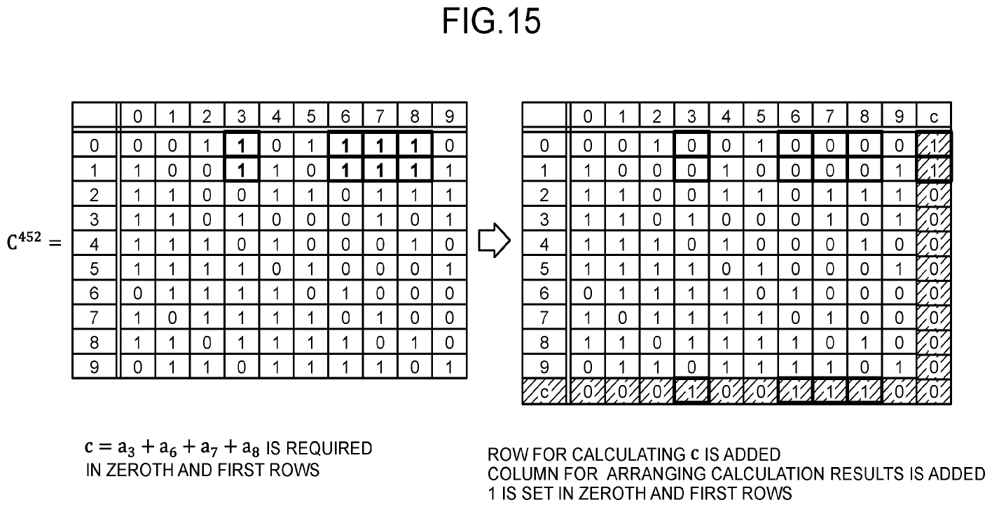

The sharing of XOR operations may be obtained by any method, and is obtained by, for example, the following method. FIG. 15 is a diagram illustrating an example of an XOR operation sharing method. In FIG. 15, to simplify the description, an example of generating a tensor sharing XOR operations, which is used in the tensor corresponding to C⁴⁵² mentioned in FIG. 14, will be described.

In the tensor in FIG. 15, for example, 1 is set in the third column, the sixth column, the seventh column, and the eighth column in the zeroth and first rows. This means that the addition (XOR) corresponding to a₃+a₆+a₇+a₈ as is required in common in the zeroth and first rows. For example, the XOR operation can be shared by the following procedure.
Add the row for calculating a₃+a₆+a₇+a₈ as to the bottom row of the tensor. In the added row, a value of 1 is set only in the third, sixth, seventh, and eighth columns corresponding to a₃, a₆, a₇, and a₈ to perform only the XOR corresponding to a₃+a₆+a₇+a₈.
The column for arranging the calculation results is added as the rightmost column of the tensor. In the added column, a value of 1 is set only in the zeroth and first rows. Note that the values of each of the third, sixth, seventh, and eighth columns in the zeroth and first rows are changed to zero.

A connected tensor before the sharing is referred to as a pre-deformation tensor. The pre-deformation tensor is generated as a tensor in which a vector obtained by one-dimensionalizing a j-th (j is 0≤j≤J−1, and J is the total number of the plurality of tensors) tensor among the plurality of tensors obtained in the procedure (P6) is set as a j-th row vector.

The tensor (connected tensor) after the sharing is generated by, for example, the following procedure.
Among two or more row vectors of the pre-deformation tensor, the values of two or more columns (hereinafter referred to as target columns) of a row vector whose target columns are commonly 1 (hereinafter referred to as target row vector) are changed to zero.
A row vector in which the values of the target columns are 1 and the values of other columns are 0 is added to the pre-deformation tensor.
A column in which the value of a row corresponding to the target row vector is 1 and values of other rows are 0 is added to the pre-deformation tensor.

In the present embodiment, the XOR operation is shared based on the connected tensor obtained by connecting the plurality of tensors. Since the connected tensor includes more rows, the possibility of finding the XOR operation that can be shared can be increased. Therefore, the scale of the circuit for the XOR operation can be more efficiently reduced. Note that the pre-deformation tensor may be used as the connected tensor without performing the sharing of (P7).

Next, (P8) will be described. In (P8), the arithmetic unit 110 is configured (designed) to perform the XOR operation according to the connected tensor after the sharing. The configuration of the arithmetic unit 110 may be performed by any conventionally used method. For example, a method using a tool or the like that performs circuit design in a hardware description language at the register transfer level (RTL) can be applied. When the tool has an optimization function for sharing XOR operations, the procedures (P7) and (P8) may be performed together using such a tool.

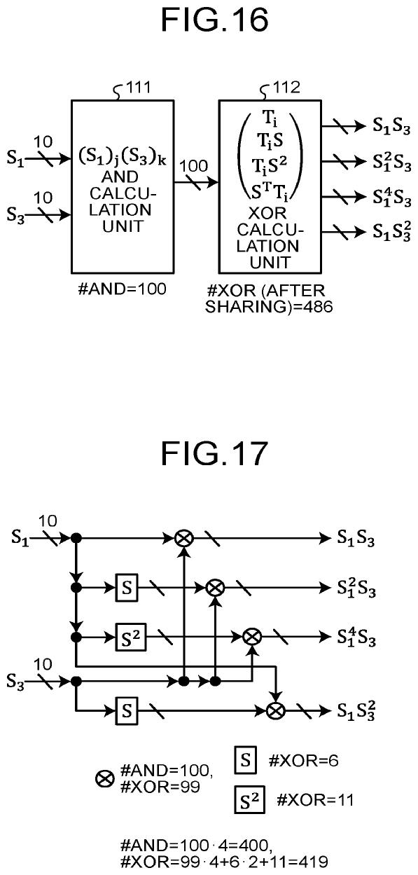

The arithmetic unit 110 is configured by the above procedure. FIG. 16 is a diagram illustrating a configuration example of the arithmetic unit 110 (AND calculation unit 111 and XOR calculation unit 112). FIG. 16 illustrates an example of the arithmetic unit 110 that performs the multiplications S₁S₃, S₁²S₃, S₁⁴S₃, and S₁S₃² in the case of m=10.

The AND calculation unit 111 calculates the AND value that is the result of the AND operation of the elements a and b of the Galois field. The AND value includes m×m components that are the results of the AND operation of the m components of the element a and the m components of the element b (hereinafter, arithmetic components). In the example of FIG. 16, the AND calculation unit 111 calculates (S₁)ⱼ(S₃)ₖ (an example of the AND value) that is the multiplication (AND) of the syndromes S₁ (an example of the element a) and S₃ (an example of the element b) to be input. Since each syndrome is a 10-dimensional vector, the AND calculation unit 111 performs the AND operation 10×10=100 times, and outputs 100 arithmetic components, which are the results of the calculation.

For each of a plurality of mutually different sets of (u, v), the XOR calculation unit 112 calculates a \hat{ } (2^{u})×b\hat{ } (2^{v}), which is a product of the 2^{u}-th power of the element a and the 2^{v}-th power of the element b, from the XOR operation based on the AND value and the connected tensor obtained by collecting the plurality of tensors different for each set.

Each of the plurality of tensors can be interpreted as including m×m components (tensor components) indicating whether or not each arithmetic component is used in the XOR operation. For example, the tensor component 1 represents that the corresponding arithmetic component is used in the XOR operation, and the tensor component 0 represents that the corresponding arithmetic component is not used in the XOR operation. The XOR calculation unit 112 performs the XOR operation using the arithmetic component indicated to be used in the XOR operation by the tensor component, that is, the arithmetic component corresponding to the tensor component 1, and calculates a \hat{ } (2^{u})×b \hat{ } (2^{v}).

In the example of FIG. 16, the elements a and b correspond to the syndromes S₁ and S₃. In addition, the four types of multiplications correspond to sets of (u, v) and tensors as follows.
S₁S₃: (u, v)=(0, 0), Tᵢ
S₁²S₃: (u, v)=(1, 0), TᵢS
S₁⁴S₃: (u, v)=(2, 0), TᵢS₂
S₁S₃²: (u, v)=(0, 1), S^{T}Tᵢ

Therefore, in the example of FIG. 16, the XOR calculation unit 112 calculates the four types of multiplications S₁S₃, S₁²S₃, S₁⁴S₃, and S₁S₃² from the XOR operation based on the AND value calculated by the AND calculation unit 111 and the connected tensor obtained by connecting the four types of tensors (Tᵢ, TᵢS, TᵢS², and S^{T}Tᵢ).

In the lower part of FIG. 16, an example of the number of calculations required in the AND calculation unit 111 and the XOR calculation unit 112 is illustrated. For example, the AND calculation unit 111 needs to perform the AND operation 10×10=100 times as described above. The XOR calculation unit 112 needs to perform the XOR operation 486 times, for example, when the connected tensor after the sharing is used.

FIG. 17 is a diagram illustrating an example (hereinafter, a comparative example) of a circuit that calculates four types of multiplications S₁S₃, S₁²S₃, S₁⁴S₃, and S₁S₃² without using the method of the present embodiment. The comparative example corresponds to an example in which four different types of arguments are calculated and four types of AND operations are performed as illustrated in the center of FIG. 11. That is, in the comparative example, four multipliers indicated by circular symbols are used.

The four multipliers perform the AND operation 100 times and the XOR operation 99 times. S and S² correspond to circuits for calculating the square and the fourth power for calculating arguments. The circuit (S) for calculating the square requires, for example, six XOR operations. The circuit (S²) for calculating the fourth power requires, for example, 11 XOR operations. When these are summed up, 400 AND operations and 419 XOR operations are required in the comparative example.

When the circuit scale is compared, for example, it is desirable to consider the number of transistors required for each operation (AND operation and XOR operation). If the ratio of the circuit scale between the AND operation and the XOR operation is set to, for example, 6:10 in consideration of the ratio of the number of transistors, the AND calculation unit 111 in FIG. 16 of the present embodiment can reduce the circuit scale by 75% as compared with the circuit for the AND operation in the comparative example. Although the circuit scale of the XOR calculation unit 112 is increased by 16% as compared with the circuit for the XOR operation in the comparative example, the circuit scale of the entire arithmetic unit 110 is reduced by approximately 17% as compared with the comparative example.

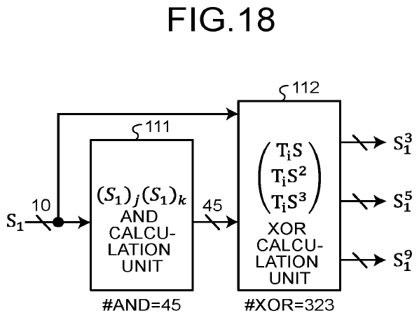

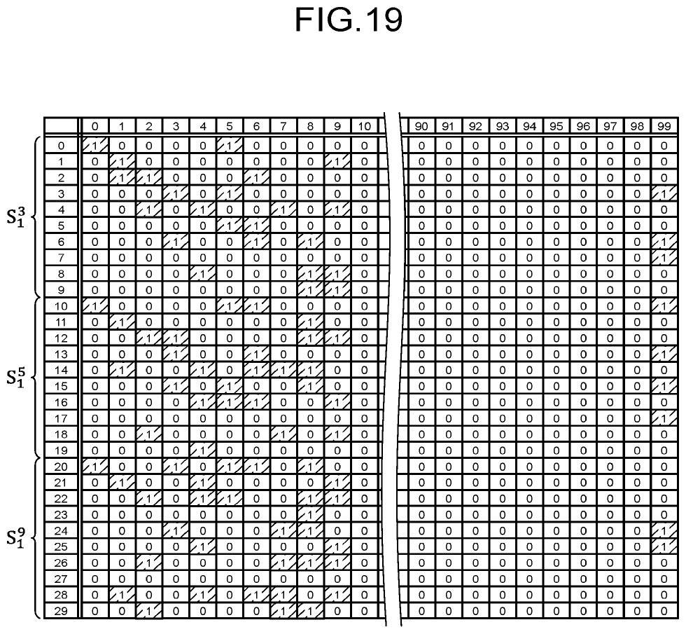

FIG. 18 is a diagram illustrating another configuration example of the arithmetic unit 110 (AND calculation unit 111 and XOR calculation unit 112). FIG. 18 illustrates an example of the arithmetic unit 110 that performs the multiplications S₁³, S₁⁵, and S₁⁹ in the case of m=10. FIG. 19 is a diagram illustrating an example of the connected tensor corresponding to the XOR operation by the arithmetic unit 110 (XOR calculation unit 112) in FIG. 18.

The arithmetic unit 110 in FIG. 18 can be interpreted as an example of the case where the two elements a and b to be multiplied are the same element c. That is, the AND calculation unit 111 calculates an AND value, which is the result of the AND operation of the elements c and c of the Galois field. In the example of FIG. 18, the AND calculation unit 111 calculates (S₁)ⱼ(S₁)ₖ (an example of the AND value) that is the multiplication (AND) of the syndromes S₁ (an example of the element c) and S₁ (an example of the element c) to be input.

Since the multiplication uses the same element c (=S₁) as the argument, the calculation of the set where j=k is not required, and the input S₁ may be output as it is. In addition, since the AND operation where j and k are interchanged leads to the same value, only one of the calculations may be performed. Therefore, the AND calculation unit 111 illustrated in FIG. 18 requires 45 (=₁₀C₂) AND operations.

For each of a plurality of mutually different sets of (u, v), the XOR calculation unit 112 calculates c \hat{ } (2^{u})×c \hat{ } (2^{v}), which is a product of the 2^{u}-th power of the element c and the 2^{v}-th power of the element c, from the XOR operation based on the AND value and the connected tensor obtained by collecting the plurality of tensors different for each set.

In the example of FIG. 18, the element c corresponds to the syndrome S₁. In addition, the three types of multiplications correspond to sets of (u, v) and tensors as follows.
S₁³: (u, v)=(0, 1), TᵢS
S₁⁵: (u, v)=(0, 2), TᵢS²
S₁⁹: (u, v)=(0, 3), TᵢS³

In the example of FIG. 18, the AND calculation unit 111 needs to perform the AND operation 45 times as described above. The XOR calculation unit 112 needs to perform the XOR operation 323 times, for example, when the connected tensor after the sharing is used.

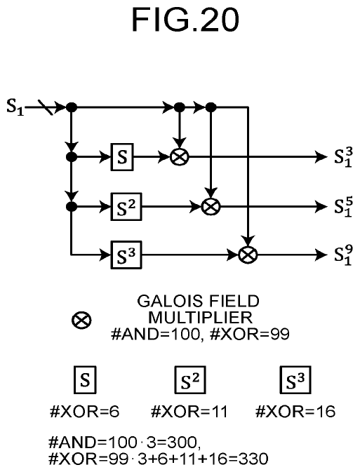

FIG. 20 is a diagram illustrating a comparative example of a circuit corresponding to FIG. 18. In the comparative example of FIG. 20, 300 AND operations and 330 XOR operations are required. If the ratio of the circuit scale between the AND operation and the XOR operation is set to, for example, 6:10, as described above, the AND calculation unit 111 in FIG. 18 can reduce the circuit scale by 85% as compared with the circuit for the AND operation in the comparative example. The XOR calculation unit 112 has a circuit scale similar to that of the circuit for the XOR operation in the comparative example. In the entire arithmetic unit 110, the circuit scale is reduced by approximately 31% as compared with the comparative example.

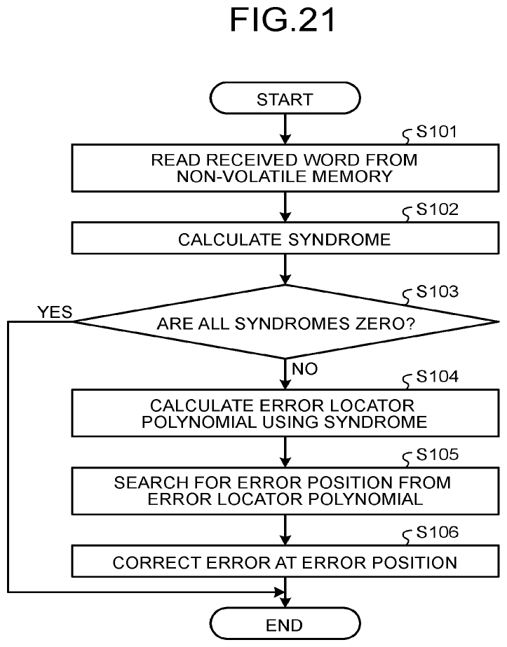

Next, the flow of decoding processing by the memory system 1 will be described. FIG. 21 is a flowchart illustrating an example of decoding processing according to the present embodiment.

The control unit 11 reads an error correction code from the non-volatile memory 20, and obtains the received word (step S101). In addition, the control unit 11 instructs the decoder 18 to start decoding.

The syndrome calculation unit 101 of the decoder 18 calculates the syndrome from the received word (step S102) . The decoder 18 determines whether or not all the calculated values of the syndromes are 0 (step S103).

When all the syndromes are 0 (step S103: Yes), since it can be determined that there is no error in the received word, the decoder 18 ends the decoding processing. When all the syndromes are not 0 (step S103: No) , the error locator polynomial calculation unit 102 calculates the error locator polynomial using the syndromes according to the PGZ method (step S104). At this time, the multiplication of the syndrome is calculated by the arithmetic unit 110 for at least some coefficients of the error locator polynomial.

The error position calculation unit 103 searches for the error position based on the calculated error locator polynomial (step S105). The bit flipping unit 104 corrects the error by inverting (bit flipping) the bit at the error position obtained by the searching (step S106), and ends the decoding processing.

As described above, according to the present embodiment, it is possible to suppress an increase in the circuit scale for performing the multiplication of the Galois field.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An arithmetic circuitry configured to:
calculate an AND value that is a result of an AND operation of an element a and an element b of a Galois field; and
calculate, for each of a plurality of mutually different sets of (u, v), a \hat{ } (2^{u})×b \hat{ } (2^{v}), which is a product of a 2^{u}-th power of a and a 2^{v}-th power of b, from an XOR operation based on the AND value and a connected tensor obtained by collecting a plurality of tensors different for each set.

2. The arithmetic circuitry according to claim 1, wherein the Galois field has a number of elements of 2^{m} (m is an integer of 2 or more),
an element of the Galois field is represented by an m-dimensional vector including m components having a value of 0 or 1, and
each of a plurality of the tensors for an i-th component (i is an integer satisfying 0≤i≤m−1) of the m-dimensional vector is expressed by a following formula (1) including a tensor Tᵢ defined for the i-th component, a linear operation S^{u} representing a 2^{u}-th power, and a linear operation S^{v} representing a 2^{v}-th power.
(S^{v})^{T}×Tᵢ×S^{u} (1)

3. The arithmetic circuitry according to claim 2, wherein
the connected tensor is defined by m tensors corresponding to m components of the m-dimensional vector, and
the connected tensor corresponding to the i-th component of the m-dimensional vector is a tensor obtained by collecting a plurality of the tensors represented by the formula (1).

4. The arithmetic circuitry according to claim 2, wherein
the AND value includes m×m arithmetic components that are results of AND operations of m components of the element a and m components of the element b,
each of the plurality of tensors includes m×m tensor components indicating whether or not each of the arithmetic components is used in an XOR operation, and
the XOR operation is performed by using the arithmetic component indicated to be used in the XOR operation by the tensor component to calculate a \hat{ } (2^{u})×b \hat{ } (2^{v}).

5. The arithmetic circuitry according to claim 1, wherein
the connected tensor is a tensor in which a vector obtained by one-dimensionalizing a j-th (j is 0≤j≤J−1, and J is a total number of the plurality of tensors) tensor among the plurality of tensors is set as a j-th row vector.

6. The arithmetic circuitry according to claim 1, wherein
the connected tensor is a tensor obtained by changing, among the plurality of tensors, among two or more row vectors of a pre-deformation tensor in which a vector obtained by one-dimensionalizing a j-th (j is 0≤j≤J−1, and J is a total number of the plurality of tensors) tensor is set as a j-th row vector, values of two or more target columns of a row vector whose values of the target columns are commonly 1 to 0, and adding a row vector having values of 1 in the target columns to the pre-deformation tensor.

7. The arithmetic circuitry according to claim 1, wherein
the element a and the element b are a same element c,
the AND value is calculated from an AND operation of the element c and the element c, and
c \hat{ } (2^{u})×c \hat{ } (2^{v}), which is a product of a 2^{u}-th power of c and a 2^{v}-th power of c, is calculated from an XOR operation based on the AND value and the connected tensor, for each of the plurality of mutually different sets of (u, v).

8. The arithmetic circuitry according to claim 1, wherein
the plurality of tensors are determined based on a companion matrix corresponding to a primitive polynomial of the Galois field.

9. A memory system comprising:
a non-volatile memory configured to store data encoded with an error correction code; and
a memory controller including the arithmetic circuitry according to claim 1,
the memory controller being configured to:
calculate a plurality of syndromes that are elements of a Galois field by using a received word read from the non-volatile memory;
calculate, by using a first syndrome included in the plurality of syndromes as an element a and a second syndrome included in the plurality of syndromes as an element b, a \hat{ } (2^{u})×b \hat{ } (2^{v}), which is a product of a 2^{u}-th power of a and a 2^{v}-th power of b using the arithmetic circuitry;
calculate an error position by using an error locator polynomial including the calculated product a \hat{ } (2^{u})×b \hat{ } (2^{v}) as a coefficient; and
correct an error at the calculated error position.

10. A control method of controlling a non-volatile memory, the method comprising:
storing data encoded with an error correction code in the non-volatile memory;
reading the data from the non-volatile memory as a received word;
calculating a plurality of syndromes that are elements of a Galois field by using the received word read from the non-volatile memory;
calculating, by using a first syndrome included in the plurality of syndromes as an element a and a second syndrome included in the plurality of syndromes as an element b, an AND value that is a result of an AND operation of the element a and the element b;
calculating, for each of a plurality of mutually different sets of (u, v), a \hat{ } (2^{u})×b \hat{ } (2^{v}), which is a product of a 2^{u}-th power of a and a 2^{v}-th power of b, from an XOR operation based on the AND value and a connected tensor obtained by collecting a plurality of tensors different for each set;
calculating an error position by using an error locator polynomial including the calculated product a \hat{ } (2^{u})×b \hat{ } (2^{v}) as a coefficient; and
correcting an error at the calculated error position.

11. The control method according to claim 10, wherein
the Galois field has a number of elements of 2^{m} (m is an integer of 2 or more),
an element of the Galois field is represented by an m-dimensional vector including m components having a value of 0 or 1, and
each of a plurality of the tensors for an i-th component (i is an integer satisfying 0≤i≤m−1) of the m-dimensional vector is expressed by a following formula (1) including a tensor Tᵢ determined for the i-th component, a linear operation S^{u} representing a 2^{u}-th power, and a linear operation S^{v} representing a 2^{v}-th power.
(S^{v})^{T}×Tᵢ×S^{u} (1)

12. The control method according to claim 11, wherein
the connected tensor is defined by m tensors corresponding to m components of the m-dimensional vector, and
the connected tensor corresponding to the i-th component of the m-dimensional vector is a tensor obtained by collecting a plurality of the tensors represented by the formula (1).

13. The control method according to claim 11, wherein the AND value includes m×m arithmetic components that are results of AND operations of m components of the element a and m components of the element b,
each of the plurality of tensors includes m×m tensor components indicating whether or not each of the arithmetic components is used in an XOR operation, and
the XOR operation is performed by using the arithmetic component indicated to be used in the XOR operation by the tensor component to calculate a \hat{ } (2^{u})×b \hat{ } (2^{v}).

14. The control method according to claim 10, wherein
the connected tensor is a tensor in which a vector obtained by one-dimensionalizing a j-th (j is 0≤j≤J−1, and J is a total number of the plurality of tensors) tensor among the plurality of tensors is set as a j-th row vector.

15. The control method according to claim 10, wherein
the connected tensor is a tensor obtained by changing, among the plurality of tensors, among two or more row vectors of a pre-deformation tensor in which a vector obtained by one-dimensionalizing a j-th (j is 0≤j≤J−1, and J is a total number of the plurality of tensors) tensor is set as a j-th row vector, values of two or more target columns of a row vector whose values of the target columns are commonly 1 to 0, and adding a row vector having values of 1 in the target columns to the pre-deformation tensor.

16. The control method according to claim 10, wherein
the element a and the element b are a same element c,
the AND value is calculated from an AND operation of
the element c and the element c, and
C \hat{ } (2^{u})×c \hat{ } (2^{v}), which is a product of a 2^{u}-th power of c and a 2^{v}-th power of c, is calculated from an XOR operation based on the AND value and the connected tensor, for each of the plurality of mutually different sets of (u, v).

17. The control method according to claim 10, wherein
the plurality of tensors are determined based on a companion matrix corresponding to a primitive polynomial of the Galois field.
